(19) United States
(12) Patent Application Publication
(10) Pub. No.: US 2020/0282552 A1
(43) Pub. Date: Sep. 10, 2020

(54) MAGNETIC BIASING ASSEMBLY

(71) Applicant: Genesis Robotics and Motion Technologies Canada, ULC, Langley (CA)

(72) Inventor: James Klassen, Surrey (CA)

(21) Appl. No.: 16/651,441

(22) PCT Filed: Sep. 27, 2018
(86) PCT No.: PCT/IB18/57524

§ 371 Date: Mar. 27, 2020

Related U.S. Application Data
(60) Provisional application No. 62/565,331, filed on Sep. 29, 2017.

(51) Int. Cl. B25J 9/12; H02K 7/00; H02K 1/17; H02K 1/27; H02K 7/14; B25J 17/00; B25J 9/10; F16F 6/00

(52) U.S. Cl. CPC B25J 9/12; H02K 7/003; H02K 1/17; F16F 6/005; H02K 7/14; B25J 17/00; B25J 9/108; H02K 1/27

(57) ABSTRACT

The application relates to a magnetic biasing assembly. The magnetic biasing assembly comprises an outer part, having a first permanent magnet and an outer ferromagnetic annulus disposed radially outwardly of the first permanent magnet; and an inner part, having a second permanent magnet and an inner ferromagnetic annulus disposed radially inwardly of the second permanent magnet. The outer and inner parts are rotatable relative to each other about an axis to move the inner and outer parts into and out of an equilibrium position with each other. When the inner and outer parts are moved out of the equilibrium position, the first and second permanent magnets are arranged to generate a magnetic restoring moment between the inner and outer parts in a direction towards the equilibrium position.

### FIELD OF THE DISCLOSURE

The present disclosure relates to a magnetic biasing assembly, an actuator assembly and a robot arm.

### BACKGROUND OF THE DISCLOSURE

It is known to lift a payload using an arm pivotable at a joint, and to actuate the arm by way of an electric motor. The weight of the payload and the arm itself must also be countered. However, this typically involves supplying an electrical current to the electric motor to resist the weight of the arm and the payload even in cases when the arm is stationary. Therefore, a more efficient way to actuate an arm is desirable.

### SUMMARY OF THE DISCLOSURE

The present disclosure relates to a passive permanent magnet biasing assembly which provides a counter balance to at least part of the weight of the arm and/or of a payload attached to the arm. By providing such a passive system using permanent magnets it is possible to reduce the energy required to maintain the arm in a desired position and to move the arm. As such, the torque required from an actuator, such as an electric motor, to move the robot arm or maintain it in position can be minimised. Furthermore, by providing a passive system that acts as a counter balance to at least part of the weight of the arm and/or of a payload attached to the arm, it is possible to increase the load that an arm is able to support and lift without increasing the performance of the electric motor.

By providing a passive system using permanent magnets it is possible to provide an arm that supports its own weight without the need for an active balancing system, nor a frictional or locking arrangement.

According to first aspect of the disclosure, there is provided a magnetic biasing assembly comprising: an outer part, having a first permanent magnet and an outer ferromagnetic annulus disposed radially outwardly of the first permanent magnet; and an inner part, having a second permanent magnet and an inner ferromagnetic annulus disposed radially inwardly of the second permanent magnet; wherein the outer part and the inner part are rotatable relative to each other about an axis to move the inner part and outer part into and out of an equilibrium position with each other, and wherein, when the inner part and the outer part are moved out of the equilibrium position, the first and second permanent magnets are arranged to generate a magnetic restoring moment between the inner and outer parts in a direction towards the equilibrium position.

With such an arrangement, there is provided a means for providing a moment by passive means, allowing a counterbalancing moment to be provided with no external energy input required.

Further, magnetism is a conservative force and so any work done against the magnetic moment will be conserved as magnetic potential energy and can be recovered by movement in the opposite direction.

The ferrous annuli can improve the magnetic coupling of the first and second permanent magnets when the elements are displaced from their equilibrium position, thereby making the magnetic moment less variable with angle from equilibrium.

The magnetic moment may be substantially constant through 140° of relative rotation between the inner and outer parts, optionally through 160° of relative rotation. This may provide a more consistent magnetic moment opposing the weight moment. Thus, the efficiency of the actuator arrangement may be improved and the overall arrangement may be more controllable.

Each of the first and second permanent magnets may be annular or part annular, forming a circumferential sub-section of an annular form.

Each of the first and second permanent magnets may comprise two permanent magnet elements, wherein the two magnet elements of each of first permanent magnet and the second permanent magnet are arranged adjacent in an axial direction and with opposite polarity. This may increase the strength of the magnetic moment by providing a complete low reluctance circuit for the magnetic flux. The overall magnetic moment of the actuator arrangement having the axially adjacent magnets may be more than double that of an arrangement having only a single magnet associated with each of the inner and outer parts.

At least one of the first permanent magnet and the second permanent magnet may extend around less than one quarter of the circumference of the respective inner part and outer part.

The inner part may comprise a third permanent magnet diametrically opposite the first permanent magnet and wherein the outer part further comprises a fourth permanent magnet diametrically opposite the second permanent magnet. With such an arrangement, the magnets may provide a magnetic moment without exerting any shear force on the motor.

A bearing may be disposed between the outer part and the inner part.

The magnetic biasing assembly may provide the magnetic restoring moment in the absence of any external electrical voltage.

The magnetic moment may vary substantially trapezoidally with angle of rotation from equilibrium. The inner part and the outer part may have at least two equilibrium positions and, optionally, wherein the inner part and the outer part have at least three equilibrium positions.

According to another aspect of the disclosure, there is provided an actuator assembly comprising: an electric motor comprising: a stator; and a rotor rotatable relative to the stator; and the magnetic biasing assembly as set out above; wherein the electric motor is arranged to generate a moment about the axis of the magnetic biasing assembly.

The electric motor and the magnetic biasing assembly may be mechanically coupled. The rotor of the electric motor may be arranged to rotate about the axis of the magnetic biasing assembly

According to another aspect of the disclosure, there is provided a robot arm comprising: a hinge joint pivotable about a hinge axis, and the actuator assembly as described above, wherein the actuator assembly is arranged to exert a moment about the hinge axis.

Equally, there may be provided an arm having the magnetic biasing assembly as described above and no electric motor. Such an arm will be combinable with any relevant feature described herein.

The magnetic moment may oppose a weight moment generated at the hinge joint by the weight of the robot arm. With such an arrangement, the actuator assembly may have improved energy efficiency, in particular when the robot arm is unladen.

The magnetic moment may be at least 70%, optionally at least 90%, further optionally at least 110%, of the weight moment when the robot arm is at 45° to vertical. This means that the energy input required to keep the robot arm at rest when in a non-vertical position may be reduced to substantially nil. When the magnetic moment is greater than the weight moment of the arm, the energy efficiency of the arm may be increased when the arm carries a payload for a significant proportion of its operational time.

The magnetic moment may be greater than the weight moment of the robot arm when the robot arm is horizontal. With such an arrangement, the payload capacity of the robot arm may be significantly increased.

According to another aspect of the disclosure, there is provided an actuator assembly comprising: an actuator arranged to generate a moment about a drive axis; and a magnetic biasing assembly comprising: a stator, having a first permanent magnet; and a rotor, having a second permanent magnet; wherein the rotor is rotatable relative to the stator about the drive axis to move the second permanent magnet into and out of an equilibrium position with the second permanent magnet, and wherein, when the first permanent magnet and the second permanent magnet are not in the equilibrium position, the first permanent magnet is arranged to exert a force on the second permanent magnet so as to generate a magnetic restoring moment about the drive axis between the stator and rotor in a direction towards the equilibrium position.

With such an arrangement, there is provided an actuator that can have reduced energy use.

The actuator may comprise an electric motor having a motor stator, and a motor rotor, rotatable relative to the stator, the electric motor being arranged to drive a drive shaft.

The drive axis may be offset from the drive shaft of the electric motor.

### BRIEF DESCRIPTION OF THE DRAWINGS

Embodiments of the disclosure will now be described with reference to the accompanying drawings, in which:

FIG. 1 shows a robot arm;

FIG. 2 shows a schematic view of an actuator assembly;

FIG. 3 shows a magnetic biasing assembly;

FIG. 4 shows a cross section of the magnetic biasing assembly; and

FIG. 5 shows a graph of magnetic moment against angular rotor position.

### DETAILED DESCRIPTION OF EMBODIMENT(S)

Terms used in this specification are intended to have their normal English meanings. For the avoidance of doubt, the following terms are clarified.

The term “equilibrium position” used herein is intended to mean a stable equilibrium, such that a small displacement from that position will be opposed by a torque generated passively. The equilibrium position for two magnets or two parts connected to magnets is the equilibrium position for those magnets or parts in the absence of other external forces. External forces may include a motor torque or weight of an object connected to one of the magnets or parts.

The term “ferromagnetic”, in reference to a material, is intended to describe a material that is susceptible of being magnetised and/or that will conduct magnetic flux.

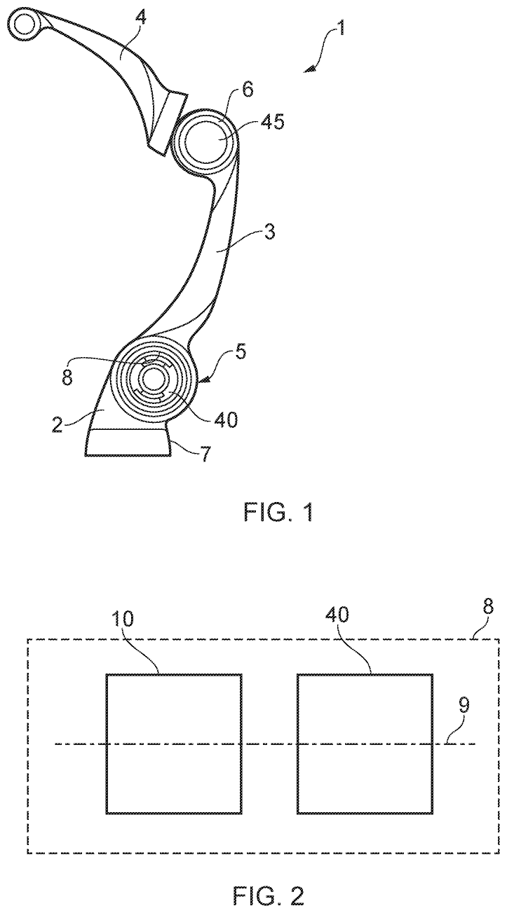

FIG. 1 shows a motor arm 1. The motor arm 1 has a base 2, a bicep 3 and forearm 4. The bicep 3 connects to the base 2 by a shoulder joint 5. The forearm 4 connects to the bicep 3 by an elbow joint 6. The base 2 has a base actuator 7. The shoulder joint 5 has a shoulder actuator 40. The elbow joint 6 has an elbow actuator 45.

In the robot arm 1, the bicep 3, elbow joint 6 and forearm 4 all have weights which will exert a moment about the shoulder joint 5, described as a “weight moment” in this specification. Were the shoulder actuator 40, which in the present embodiment is an electric motor (refer to FIG. 2), to resist this weight, then a significant amount of energy would be required to drive the electric motor while in a stationary position. This problem is exacerbated when the robot arm is carrying a payload.

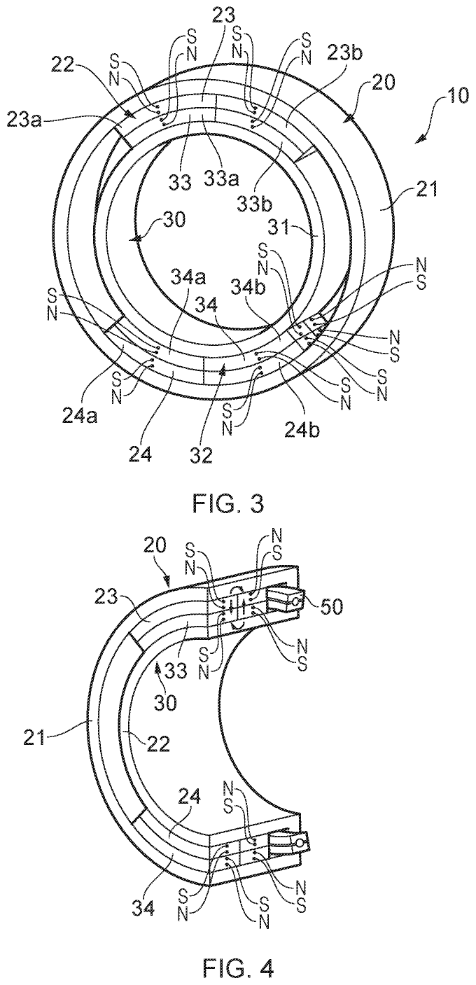

The shoulder joint 5 comprises a magnetic biasing assembly 10. The magnetic biasing assembly is shown in FIGS. 2 and 3. By using the magnetic biasing assembly 10 in the shoulder joint 5, the weight moment can be opposed by the magnetic moment of the magnetic biasing assembly 10. The magnetic biasing assembly 10 and actuator 40 together form an actuator assembly 8. A schematic view of the actuator assembly 8 is shown in FIG. 2. The actuator assembly 8 has a hinge axis 9. The hinge axis 9 is shown co-axial with a drive axis of the actuator 40, but may be offset from the hinge axis 9.

The magnetic biasing assembly 10 will now be described. The magnetic biasing assembly 10 is described herein by use in the shoulder joint 5 of the robot arm 1. It will be recognised that the magnetic biasing assembly 10 may be used in applications other than in a robot arm. The magnetic biasing assembly 10 may be used in applications with and without the actuator 40.

The magnetic biasing assembly 10 comprises an outer part 20 and an inner part 30. The outer part 20 is a stator and the inner part 30 is a rotor. In an alternative arrangement, the outer part 20 is the rotor and the inner part 30 is the stator. The inner part 30 is received by the outer part 20.

The outer part 20 comprises an outer backiron 21 and an outer magnetic arrangement 22. The outer backiron 21 is an annulus. The outer backiron 21 is fixed in position when the outer part 20 forms the stator. The outer backiron 21 is formed from a ferrous material. The outer backiron 21 is formed as an outer ferromagnetic annulus. Magnetic flux is conducted by the outer backiron 21 from the outer magnetic arrangement 22. The outer magnetic arrangement 22 is formed from permanent magnets.

The outer magnetic arrangement 22 comprises a first outer magnet 23 and a second outer magnet 24. The first and second outer magnets 23, 24 are diametrically opposite. The first and second outer magnets 23, 24 act as magnetic members.

In the example shown in FIG. 1, there are two circumferentially adjacent first outer magnet elements 23a, 23b attached to the outer backiron 21. The first outer magnet elements 23a, 23b have the same orientation, so that the north poles of the two magnet elements 23a, 23b are adjacent and the south poles are adjacent. It will be understood that the number of circumferentially adjacent first outer magnet elements may differ, and may include one circumferentially adjacent first outer magnet element.

Opposite the first outer magnet 23 is the second outer magnet 24. The second outer magnet comprises two second outer magnet elements 24a, 24b. The second outer magnet 24 is diametrically opposite the first outer magnet 23 with opposing magnetic orientation, so that the first outer magnet 23 has its south poles facing radially outwards, whereas the second outer magnet 24 has its north poles facing radially outwards. The second outer magnet elements 24a, 24b have the same orientation, so that the north poles of the two magnet elements 24a, 24b are adjacent and the south poles are adjacent. It will be understood that the number of circumferentially adjacent second outer magnet elements may differ. In an alternative embodiment, the second outer magnet 24 is omitted.

The outer backiron 21 is arranged radially outside the first and second outer magnets 23, 24. The outer backiron 21 is magnetically coupled to the first and second outer magnets 23, 24. The outer backiron 21 forms part of a magnetic circuit for conducting magnetic flux from the first and second outer magnets 23, 24.

The inner part 30 comprises an inner backiron 31 and an inner magnetic arrangement 32. The inner backiron 31 is an annulus. The inner backiron 31 is rotatable relative to the outer backiron 21. The inner part 30 is rotatable about the outer part 20 about an axis. The axis forms a hinge axis of the shoulder joint 5. The inner backiron 31 is formed from a ferrous material. The inner backiron 31 is formed as an inner ferromagnetic annulus. Magnetic flux is conducted by the inner backiron 31 from the inner magnetic arrangement 32. The inner magnetic arrangement 32 is formed from permanent magnets.

The inner magnetic arrangement 32 comprises a first inner magnet 33 and a second inner magnet 34. The first and second inner magnets 33, 34 are diametrically opposite. The first and second outer magnets 23, 24 act as magnetic members.

Two circumferentially adjacent first inner magnet elements 33a, 33b are attached to the outer backiron 31. The first inner magnet elements 33a, 33b have the same orientation, so that the north poles of the two magnet elements 33a, 33b are adjacent and the south poles are adjacent. It will be understood that the number of circumferentially adjacent first inner magnet elements may differ. While the first and second inner and outer magnets are shown as circumferentially adjacent pairs, each of the pairs may be replaced by a single magnet.

Opposite the first inner magnet 33 is the second inner magnet 34. The second inner magnet comprises two second inner magnet elements 34a, 34b. The second inner magnet 34 is diametrically opposite the first inner magnet 33 with opposing magnetic orientation, so that the first inner magnet 33 has its south poles facing radially outwards, whereas the second inner magnet 34 has its north poles facing radially outwards. The second inner magnet elements 34a, 34b have the same orientation, so that the north poles of the two inner magnet elements 34a, 34b are adjacent and the south poles are adjacent. It will be understood that the number of circumferentially adjacent second inner magnet elements may differ, and may include one circumferentially adjacent second inner magnet element. In an alternative embodiment, the second inner magnet 34 is omitted.

As such, the first and second inner magnets 33, 34 are permanent magnets and are arranged diametrically opposite each other, with opposing polarity, similarly to the first and second outer magnets 23, 24, so that the first inner magnets 33 have their south poles radially outward and the second inner magnets 34 have their north poles radially outward.

The inner backiron 31 is arranged on the radially inner side of the first and second inner magnets 33, 34 and magnetically coupled to the first and second inner magnets 33, 34 so as to conduct magnetic flux from the first and second inner magnets 33, 34 for forming part of a magnetic circuit with the first and second inner magnets 33, 34.

FIGS. 3 and 4 show the inner part 30 and outer part 20 in an equilibrium position. As the opposing poles of the inner and outer magnets 23, 24, 33, 34 are radially aligned, there is no magnetic moment about the axis. Any small displacement from this position will result in a magnetic moment directed toward the equilibrium position. Put another way, the magnetic potential energy is at a minimum in this position.

When displaced from this position by an angle between 0° and 180°, a magnetic circuit will be formed by magnetic flux passing through the inner and outer magnets 23, 24, 33, 34 and the inner and outer backirons 31, 21, which will result in a magnetic moment in a direction toward the position shown in FIG. 3. A clockwise displacement of the inner part 20, acting as the rotor, between 0° and 180° will result in an anticlockwise magnetic moment being applied to the inner part 20 and an anticlockwise displacement of the inner part 20 between 0° and 180° will result in a clockwise magnetic moment being applied to the inner part 20.

By using the inner and outer backirons 31, 21, the strength of the magnetic moment is increased and is made more constant (i.e. less variable with angle), since the magnetic flux from the permanent magnets 23, 24, 33, 34 is conducted via the backirons 21, 31.

It is noted that there will be no torque generated when the inner part 20 is rotated exactly 180° from equilibrium. However, this position is inherently unstable and so is not considered to be an equilibrium position for the purposes of this specification.

It will be understood that, if more inner and/or outer magnets are used (e.g. two or three pairs of diametrically opposed magnets), then there will be more equilibrium positions. In one example, the outer part 20 may have two diametrically opposed pairs of outer magnets, and the inner part 30 may have a single pair of diametrically opposed magnets. This would give more than one equilibrium position, with the direction of the magnetic moment reversing multiple times in a full rotation. For brevity, such arrangements are not described further herein.

Further, FIG. 3 shows each of the first and second inner and outer magnets extending around approximately 90°. However, the magnets may each extend about 45° or 120° or more.

FIG. 4 shows a cross section of the magnetic biasing assembly and the path taken by the magnetic flux when the magnetic biasing assembly is at equilibrium.

It can be seen in FIG. 4 that the first and second outer magnets 23, 24 and the first and second inner magnets 33, 34 each comprise two axially adjacent permanent magnet elements. The pairs of axially adjacent magnet elements are aligned having opposite polarity so that one has a north pole facing radially outwardly and the other has a south pole facing radially outwardly.

By the arrangement of axially adjacent magnet elements, which have opposite polarities, there is provided a complete, low reluctance circuit when the magnetic biasing assembly 10 is in equilibrium. This is provided by the magnetic circuit shown in FIG. 4, which has magnetic flux in an axial direction within the backirons 21, 31.

The outer part 20, acting as the stator, and the inner part 30, acting as the rotor, are shown in FIG. 4 mechanically coupled by a bearing 50. It will be understood that a wide range of bearings can be used, and that, in embodiments, the bearing may be omitted.

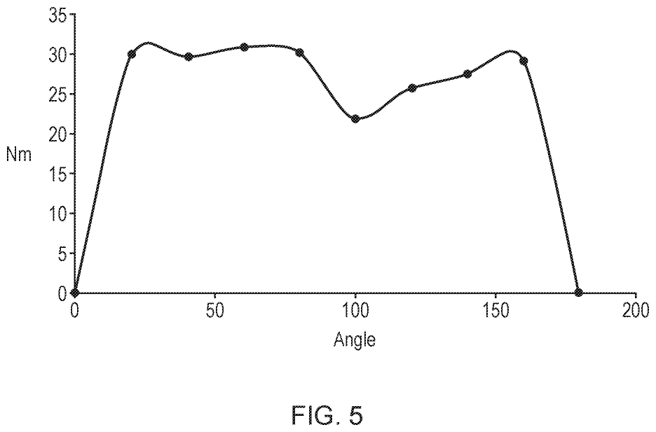

FIG. 5 gives an example set of results showing the variation of torque generated by the magnetic biasing assembly 10 with angle of rotation of the inner part 20.

As can be seen from FIG. 5, the variation is substantially trapezoidal. In particular, the torque is substantially constant between 20° and 160°. However, it will be understood that different variation of torque with angle may be possible using different magnet arrangements.

The consistent torque generated by the magnetic biasing assembly 10 means that the overall system may be easily controlled and the torque required by the electric motor 40 can be more simply determined.

Referring back to FIG. 1 showing the robot arm 1 incorporating the actuator assembly 8, the robot arm may carry a payload, for example at its free end. By using the magnetic biasing assembly of FIG. 1 in the shoulder joint, the weight moment produced by the arm, or the arm and payload, can be opposed by the magnetic moment of the magnetic biasing assembly.

This significantly reduces the amount of energy required by the electric motor 40 in order to keep the robot arm stationary.

In order to reduce the energy required by the electric motor 40, the magnetic moment, which is substantially constant, can be configured to exactly oppose the weight moment of the robot arm 1. In situations where a heavy payload is to be lifted, the magnetic moment, acting as a restoring moment, can be arranged to exceed the weight moment of the robot arm 1. This can increase the maximum payload the arm 1 is able to lift. In such a case, torque from the electric motor 40 will be required in order to move the arm 1 downwards, with the weight moment, and the arm 1 will be positioned vertically or near vertically when there is no energy supplied and no payload applied.

It is also envisaged that the actuator assembly could be incorporated within the elbow joint 6 in order to resist the weight moment of the forearm 4 and/or the payload about the elbow joint 6.

Alternatively, an actuator assembly for controlling the forearm 4 can be incorporated within the shoulder joint 5. Such an actuator assembly can control the forearm 4 via a pulley system (not shown). This allows the weight of the elbow joint 6 to be reduced, which in turn reduces the energy requirement of the actuator 40 at the shoulder joint 5.

The shoulder joint 5 may further comprise a position sensor (not shown), arranged to determine the angular position of the bicep 3. The position sensor and the electric motor 40 of the actuator assembly 9 may be coupled to a controller having a feedback system (not shown). This can allow the power supplied to the shoulder actuator assembly to be selected in order to maintain the bicep in a predetermined angular position.

The above position sensor, controller and feedback system described with reference to the shoulder joint can, additionally or alternatively, be incorporated for use with the actuator 40 for the elbow joint 6.

In an alternative embodiment, one or each of the first and second outer magnets 23, 24, or one or each of the first and second inner magnets 33, 34, is replaced by a ferromagnetic member. The ferromagnetic member is a soft ferromagnetic material, such as steel, which conducts magnetic flux.

The following relates to further embodiments of a magnetic balancing device. The further embodiments are described by reference to the Figures of the embodiment described above.

By using an array of permanent magnets on a stator and/or rotor, a progressively greater torque can be created between the stator and rotor as they rotate relative to each other. This magnetically produced torque can be for as little as one degree or less or 45 degrees or more.

If passive, and with no electromagnetic commutation, the torque direction may be reversed at one or more points in a full rotation. This is not a problem if a robotic arm, for example, is not required to move through a greater angle than the angle through which this counterbalance effect is generated.

A non-limiting example of how this device and principle can be used is as follows: A robot arm is equipped with an integrated and/or separate stator and rotor. The said stator and/or rotor are equipped with permanent magnets. The permanent magnets are arrayed such that there is a torque generated between the stator and rotor which is positive for part of the rotation and negative for part of the rotation. The positive torque is preferably, but not necessarily, for more than 15 degrees of rotation and preferably for at least 90 degrees or more. The negative torque is preferably, but not necessarily, for more than 15 degrees of rotation, and preferably for at least 90 degrees or more.

Many motion control applications, such as but not limited to robotic arms, can benefit from such a device on one or more of its actuators. The fact that the present device exerts torque in different directions at different rotational angles (for example, it can be designed to exert a clockwise torque at 90 degrees and a counter clockwise torque at −90 degrees) may benefit the robotic arm performance by opposing gravity when the robot arm is rotated in either direction from vertical.

In an embodiment, the device is optimized to provide a significant percentage of the minimum torque needed to support the robot arm and minimum payload through the full range of normal motion of the arm when in service. The present device could even be used to provide more than this minimum torque. In this case, a commutated actuator or actuators configured to rotate the robot joint on which the magnetic balancing assembly is having an effect would have to overcome the torque provided by the present device when the arm is minimally loaded. When load is added to the arm, the device continues to exert the same torque on the arm until the load is increased to the point where the commutated actuator must work in the same rotational direction as the device. As more load is added, the maximum torque of the device at a given rotational position, plus the maximum torque of the actuator at that rotational position, will be the maximum load the arm can support.

An example of how the present device can be used will now be described.

An exemplary, non-limiting, arm has a mass and centre of mass that results in a required torque at a shoulder actuator of 1 Nm when the arm is at full extension in the horizontal position. In the example, if the arm is 1 metre in length from a shoulder to a payload and is required to support a payload of 1 Newton, then a shoulder actuator (without the assistance of the device) is required to generate 2 Nm of torque in this position to support the payload and the mass of the arm.

Use of the present device to generate 2 Nm of torque in the direction that opposes gravity when the arm is horizontal, leads to the generated 2 Nm of the device plus the torque of 2 Nm of which the actuator is capable, and results in a payload capacity of 3 Nm. Such a payload is three times the payload capacity without use of the device.

Use of the present device to generate 3 Nm of torque in the direction that opposes gravity when the arm is horizontal, leads to the 3 Nm of generated torque of the device plus the 2 Nm of which the actuator is capable, and so results in a payload capacity of 4 Nm. This is four times the payload capacity without use of the device.

In such a configuration, the 1 Nm torque of the arm mass would not keep the arm horizontal against the passive torque of the present device unless the payload is 2 Newtons. If there is no payload, then the actuator would need to keep the arm in the horizontal position with a torque in the direction of gravity on the arm to overcome the torque developed in the opposite direction of the pull of gravity by the device. Use of the shoulder actuator to provide torque in the opposite direction of the present device which is assisting it, when the arm is unloaded or lightly loaded, may be considered a worthwhile trade-off because it further increases the maximum payload capacity of the arm when the arm is more heavily loaded.

A non-limiting exemplary device is described below.

The device is 1″ axially long. Steel backirons are disposed on an inner diameter of inner magnets (on the stator in this example) and on an outer diameter of the outer magnets (on the rotor of this example). In such an exemplary model a peak torque of approximately 30 Nm may be achieved, for example, which is a substantial torque for an actuator of this size. This torque can be used to assist the active torque created by a motor or actuator of a rotary device, such as but not limited to a robotic arm actuator.

An example of how this device could be used is as follows, with reference to FIG. 1 showing a schematic of a four-axis robot arm with the passive partial rotation torque assist device represented schematically in the shoulder joint. The outer rotor and permanent magnets, in this example, are fixed to the output of the shoulder actuator. The inner stator and permanent magnets are fixed to the output of the base actuator.

The device is schematically represented as being fixed between two coaxial shoulder active actuators such as, but not limited to, a direct drive motor.

FIG. 5 shows a graph of the above examples. The torque increases quickly as rotation moves from zero and then stays reasonably consistent for approximately 160 degrees before returning to zero at 180 degrees.

Further rotation would result in a similar torque curve in the opposite rotational direction. In embodiments, a more consistent maximum torque may be achieved. Other torque curves are also possible for various applications and effects.

Referring to FIG. 3, a simplified, non-limiting, example of the present device is shown. It uses two or more (two shown in this example) sets of opposite polarity magnets axially next to each other. This arrangement allows the flux to link axially through the backiron rather than circumferentially as described above.

Referring to FIG. 4, a cross section of the example device is shown with a schematic bearing. The bearing assists with relative rotation of the stator and rotor while keep them concentric to each other.

In one embodiment, the example has a combination of permanent magnets on the rotor and steel posts in place of permanent magnets (relative to the above described example) on the stator. The stator and rotor may both have soft magnetic posts and magnets or only soft magnetic posts or only permanent magnets.

Further variations of the embodiments are described below:
100% passive with attracting and repelling permanent magnets
100% passive with permanent magnets on the stator and/or rotor attracting soft magnetic material on the other of the stator and/or rotor.
100% electromagnets which are not commutate but energized with DC current to provide the required torque.
Various combinations of permanent magnets and electromagnets
Flux steering of permanent magnets with electromagnets on the Stator and/or rotor.
Varying airgap to achieve different torque vs rotation angle effects
Varying magnet angle and circumferential length to achieve different torque vs rotation angle effects
One or more principles of the present device as applied to a linear actuator.

Further examples are set out in the following clauses:
A rotary actuator with permanent magnets and no electromagnets that creates torque in one direction for 180 degrees or less and in the opposite direction for 180 degrees or less.
The previous clauses with permanent magnets on the stator and/or rotor.
A rotary actuator with permanent magnets and non-commutated electromagnets on the stator and/or rotor that creates torque in one direction for 180 degrees or less and in the opposite direction for 180 degrees or less.
The device of any of the above clauses used on its own or to assists another actuator or motor or torque producing device.
A robotic arm or other mechanism which uses the present device to assist an actively controlled actuator or motor or other torque producing device.
The previous clauses where the present device provides greater torque assistance at arm angles where the force of gravity results in greater load on the active actuator which it is assisting.
The previous clauses where the present device provides more than 100% of the torque to oppose gravitational force on the arm than is necessary at a position greater than 45 degrees from vertical (vertical being the position where there would be no torque required from the active actuator).
Any of the previous clauses where the present device acts in opposite rotational directions on either rotational direction from vertical.

Although the disclosure has been described above with reference to one or more preferred embodiments, it will be appreciated that various changes or modifications may be made without departing from the scope of the disclosure as defined in the appended claims.

1. A magnetic biasing assembly comprising:
an outer part, having a first magnetic member and an outer ferromagnetic annulus disposed radially outwardly of the first magnetic member; and
an inner part, having a second magnetic member and an inner ferromagnetic annulus disposed radially inwardly of the second magnetic member;
wherein one of the first magnetic member and the second magnetic member is a permanent magnet, and the other of the first magnetic member and the second magnetic member is one of a ferromagnetic member and a permanent magnet,
wherein the outer part and the inner part are rotatable relative to each other about an axis to move the inner part and outer part into and out of an equilibrium position with each other, and
wherein, when the inner part and the outer part are moved out of the equilibrium position, the first and second magnetic members are arranged to generate a magnetic restoring moment between the inner and outer parts in a direction towards the equilibrium position.

2. The magnetic biasing assembly of claim 1, wherein the first magnetic member and the second magnetic member are permanent magnets.

3. The magnetic biasing assembly of claim 1, wherein the first permanent magnet and the second permanent magnet each comprise two permanent magnet elements, wherein the two magnet elements of each of first permanent magnet and the second permanent magnet are arranged adjacent in an axial direction and with opposite polarity.

4. The magnetic biasing assembly of claim 1, wherein each of the first and second permanent magnets are at least part annular.

5. The magnetic biasing assembly of claim 1, wherein at least one of the first permanent magnet and the second permanent magnet extend around less than one quarter of the circumference of the respective inner part and outer part.

6. The magnetic biasing assembly of claim 1, wherein the inner part comprises a third permanent magnet diametrically opposite the first permanent magnet and wherein the outer part further comprises a fourth permanent magnet diametrically opposite the second permanent magnet.

7. The magnetic biasing assembly of claim 1, wherein the magnetic moment varies substantially trapezoidally with angle of rotation from equilibrium.

8. The magnetic biasing assembly of claim 1, wherein the magnetic moment is substantially constant through 140° of relative rotation between the inner and outer parts and, optionally, through 160° of relative rotation.

9. The magnetic biasing assembly of claim 1, wherein the inner part and the outer part have at least two equilibrium positions and, optionally, wherein the inner part and the outer part have at least three equilibrium positions.

10. The magnetic biasing assembly of claim 1, comprising a bearing between the outer part and inner part.

11. The magnetic biasing assembly of claim 1, wherein the axis is horizontal.

12. The magnetic biasing assembly of claim 1, wherein the magnetic biasing assembly provides the magnetic restoring moment in the absence of any external electrical voltage.

13. An actuator assembly comprising:
an electric motor comprising:
a stator, and
a rotor, rotatable relative to the stator; and
the magnetic biasing assembly comprising:
an outer part, having a first magnetic member and an outer ferromagnetic annulus disposed radially outwardly of the first magnetic member, and
an inner part, having a second magnetic member and an inner ferromagnetic annulus disposed radially inwardly of the second magnetic member,
wherein one of the first magnetic member and the second magnetic member is a permanent magnet, and the other of the first magnetic member and the second magnetic member is one of a ferromagnetic member and a permanent magnet,
wherein the outer part and the inner part are rotatable relative to each other about an axis to move the inner part and outer part into and out of an equilibrium position with each other,
wherein, when the inner part and the outer part are moved out of the equilibrium position, the first and second magnetic members are arranged to generate a magnetic restoring moment between the inner and outer parts in a direction towards the equilibrium position, and
wherein the electric motor is arranged to generate a moment about the axis of the magnetic biasing assembly.

14. The actuator assembly of claim 13, wherein the electric motor and the magnetic biasing assembly are mechanically coupled and the rotor of the electric motor is arranged to rotate about the axis of the magnetic biasing assembly.

15. A robot arm comprising:
a hinge joint pivotable about a hinge axis, and
the actuator assembly of claim 13,
wherein the actuator assembly is arranged to exert a moment about the hinge axis.

16. The robot arm of claim 15, wherein the magnetic restoring moment opposes a weight moment generated about the hinge joint by the weight of the robot arm.

17. The robot arm of claim 16, wherein the magnetic restoring moment is at least 70%, optionally at least 90%, further optionally at least 110%, of the weight moment when the robot arm is at 45° to vertical.

18. The robot arm of claim 16, wherein the magnetic moment is equal to or greater than the weight moment of the robot arm when the robot arm is horizontal.

19. An actuator assembly comprising:
an actuator arranged to generate a moment about a drive axis; and
a magnetic biasing assembly comprising:
a stator, having a first permanent magnet; and
a rotor, having a second permanent magnet;
wherein the rotor is rotatable relative to the stator about the drive axis to move the second permanent magnet into and out of an equilibrium position with the second permanent magnet, and
wherein, when the first permanent magnet and the second permanent magnet are not in the equilibrium position, the first permanent magnet is arranged to exert a force on the second permanent magnet so as to generate a magnetic restoring moment about the drive axis between the stator and rotor in a direction towards the equilibrium position.

20. The actuator assembly according to claim 19, wherein the actuator comprises an electric motor having a motor stator, and a motor rotor, rotatable relative to the stator, the electric motor being arranged to drive a drive shaft.

21. The actuator assembly according to claim 20, wherein the drive axis is offset from the drive shaft of the electric motor.
